(19) United States
(12) Patent Application Publication
(10) Pub. No.: US 2009/0098504 A1
(43) Pub. Date: Apr. 16, 2009

(54) Periodontal pocket depth recorder

(75) Inventors: Byron Hourmand, Vista, CA (US); Alan Hourmand, Vista, CA (US)

Correspondence Address: BYRON HOURMAND, P.O. BOX 3152, VISTA, CA, 92085, US

(73) Assignee: ADVANCED EMBEDDED TECHNOLOGIES, VISTA, CA (US)

(21) Appl. No.: 11/975,069

(22) Filed: Oct. 16, 2007

(51) Int. Cl. A61C 19/04

(52) U.S. Cl. 433/72

(57) ABSTRACT

A periodontal probe to measure and record periodontal pocket depths easily and economically by one person. The pocket depths are measured by reading markings inscribed onto the head of the instrument and data is entered into the probe via a rotary switch and an integrated pushbutton switch. The data is displayed on the probe for visual feedback. The probe also includes voice for audio feedback and commands to guide the operator through dental examination. Upon completion of dental examination, the probe is placed in a docking station and data is transferred to a Personal Computer (PC) for analysis.

### CROSS-REFERENCE TO RELATED APPLICATIONS

None.

Not Applicable.

### STATEMENT REGARDING FEDERALLY SPONSORED RESEARCH DEVELOPMENT

Not Applicable.

### BACKGROUND OF THE INVENTION

1. Field of Invention

This invention relates to a periodontal probe capable of recording periodontal pocket depths economically and easily by one person.

2. Description of the Related Art

A periodontal probe is an instrument in dentistry commonly used to measure pocket depths around a tooth in order to establish the state of health of the periodontium. There are markings inscribed onto the head of the instrument to make measurements more accurate for a dentist. The tip of the instrument is placed with light pressure into the gingival sulcus which is an area of potential space between a tooth and the surrounding tissue. The first marking visible above the pocket indicates the measurement of the pocket depth. It has been found that the average, healthy pocket depth is around 3 mm. Depths greater than 3 mm can be associated with periodontitis or other gum diseases. In general, 6 numbers are associated with the pocket depth surrounding a tooth: three numbers for front of the tooth and three numbers for back of the tooth. These numbers normally range between 1 mm and 6 mm. Normally, there are 32 teeth in the mouth. Therefore, the total number of measurements made by a dental office personnel can be as high as 196 if none of the teeth are missing.

In a general dental practice, a person makes the pocket depth measurements and relays the information by saying it out loud to a second person. The second person would then type the information in the computer. This method requires two people and if the second person looses synchronization with the first person, errors may occur.

There are several products which can be used by one person to make depth measurements. These products use ultra-sonic, or mechanical, or optical means to make accurate measurements. There are also products which use voice recognition to store the information in a computer as the personnel says the depth numbers. All of these products are costly, not viable solutions, and are not used, in general, by dentists.

### BRIEF SUMMARY OF THE INVENTION

The present invention overcomes the above problems by providing a probe that is economical and can easily be used by one person to record the pocket depths. The probe is capable of recording and storing the depth data by one person.

In the present invention, the pocket depths are measured by reading markings inscribed onto the head of the instrument as it is normally done in a dentist's office, and data is entered into the probe via a rotary switch and an integrated pushbutton switch using one finger. The data is displayed on the probe for visual feedback. The probe also generates voice feedback and voice commands using voice synthesis techniques. Audio may include depth measurements, tooth number, “front”, “back”, “low battery”, and other pertinent information. If desired, the audio may be turned off during dental examination. The probe supports several modes of operation in regards to the order of depth measurements. The modes of operation are selected via the rotary switch and pushbutton switch. For example, in one mode, the 32 teeth are divided into 4 quadrants. Each quadrant consists of 8 teeth. The probe guides the operator to measure the depths for front and back of each tooth in a quadrant. In another mode, the fronts of all 32 teeth are measured first followed by the backs. Upon completion of dental examination, the data can then be transferred to a Personal Computer (PC).

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1A shows the periodontal probe which uses a rotary encoder switch and 3-digit LCD display to show the depth sizes, tooth number, and other data.

FIG. 1B is the same probe of FIG. 1A shown from a different view.

FIG. 2A is the same probe of FIG. 1A showing three pocket measurements of 3 mm, 2 mm, and 4 mm.

FIG. 2B is the same probe of FIG. 1A showing tooth number 16 and “F” which stands for front of the tooth.

FIG. 2C is the same probe of FIG. 1A showing tooth number 16 and “b” which stands for back of the tooth.

FIG. 2D is the same probe of FIG. 1A showing “LOb” which stands for Low Battery.

FIG. 3 is the block diagram of the periodontal probe unit and a base unit which transfers the data to computer. The base unit also charges the probe's battery.

FIG. 4 shows the probe inserted into the base unit and the base unit is connected to a PC.

FIG. 5A shows another embodiment of the probe. This embodiment uses individual LEDs to indicate the pocket depth sizes. The LCD is used only to show the tooth number and other pertinent data.

FIG. 5B shows the probe of FIG. 5A with three LEDs turned on to indicate pocket measurements of 3 mm, 4 mm, and 2 mm. The LCD shows tooth number 32 and “F” which indicates front of the tooth.

FIG. 6A shows another embodiment of the probe. This embodiment uses touch control to select pocket sizes and a pushbutton switch to record the sizes.

FIG. 6B shows the probe of FIG. 6A from a different view angle.

FIG. 7 shows another embodiment of the probe and base unit. In this embodiment, all display functions are integrated into the base unit.

### DETAILED DESCRIPTION OF THE INVENTION

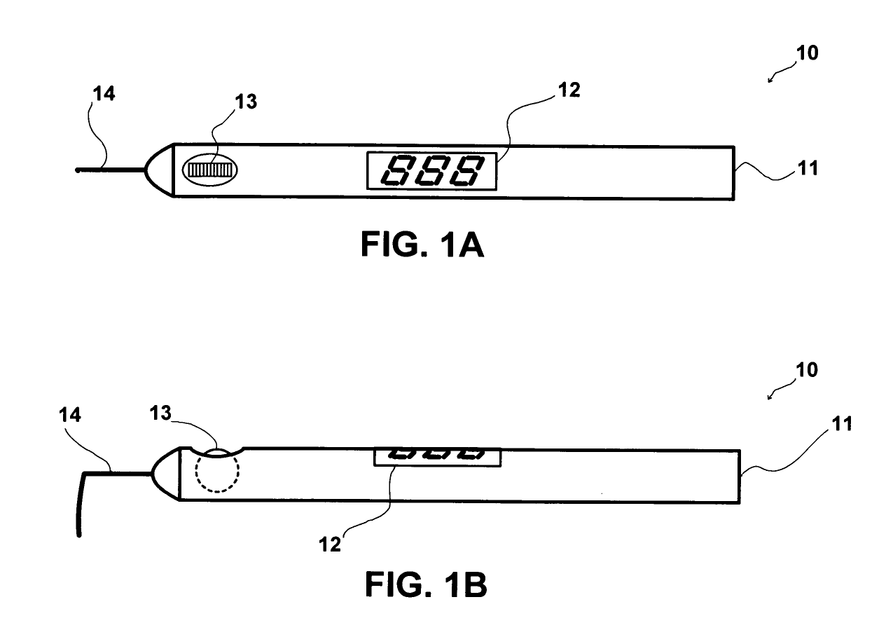

FIG. 1A shows the preferred embodiment 10 of the present invention. The probe 10 is battery operated and uses a digital encoder wheel, or an optical encoder wheel, or a digital potentiometer, or an analog potentiometer 13 with integrated pushbutton switch to select and record the pocket sizes. The probe 10 also uses a 3-digit LCD display 12 to show the pocket size data and tooth number. The display 12 is also used to show other pertinent data such as “LOb” to indicate Low Battery condition. The probe 10 also generates voice feedback and commands to guide the operator through dental examination. If desired, the operator may turn the audio off. The probe 10 uses a microcontroller and permanent memory to receive data from the wheel 13 and record the data in the probe's memory. The probe 10 also uses a radio transmitter to transmit the data to a base unit which incorporates a radio receiver circuit. FIG. 1B shows a different perspective of the preferred embodiment 10.

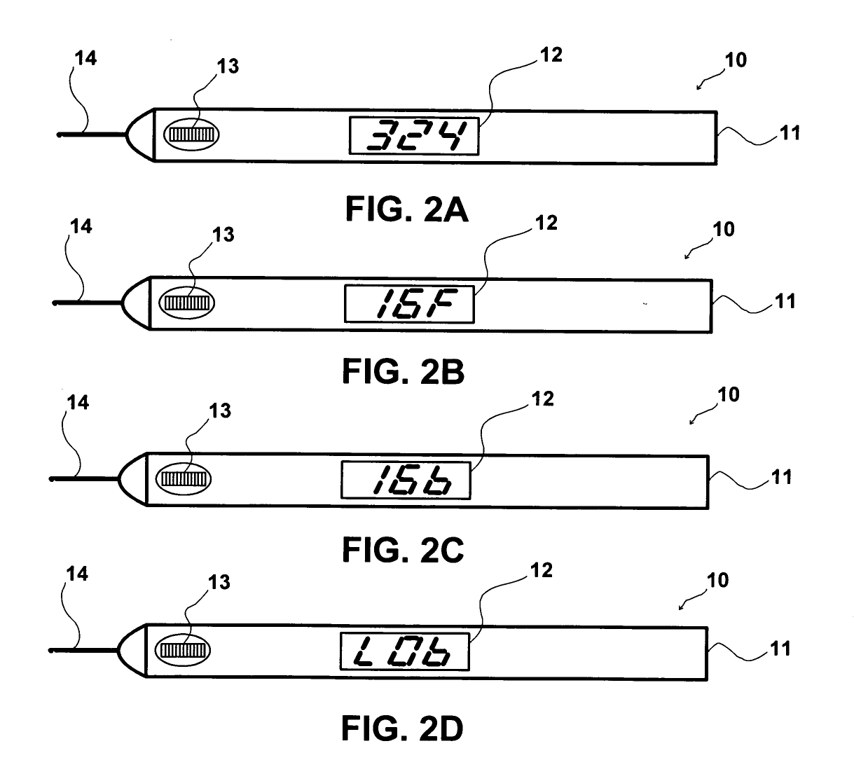

FIG. 2A shows the probe 10 with the LCD display showing “324”. The “324” data correspond to three pocket measurements of 3 mm, 2 mm, and 4 mm. FIG. 2B shows probe 10 with LCD display 12 showing “16F” which corresponds to Front of tooth number 16. The display 12 alternates between the tooth number and pocket measurements constantly until the personnel rotates the wheel 13. If tooth number is 16 and front of the tooth is being examined, the display 12 would alternate between “16F” and “000” until personnel rotates the wheel 13. When the wheel 13 is rotated, the display 12 freezes on “000” with the first digit changing to the value determined by the position of the wheel 13. The first digit also flashes until the value is selected by pressing on the wheel 13 which presses on an integral pushbutton switch. The value of the first digit would be between 1 and 6 representing 1 mm to 6 mm of pocket depth size. Once the depth is entered, the value is saved in internal memory and the second digit starts flashing awaiting the second depth value and so on. If there is a predetermined amount of time delay in entering the depth values, the LCD 12 would alternate between the tooth number and pocket sizes. After all three values have been entered, the tooth number increments and unit awaits the entry of the next set of numbers. Following the successful entry of all data for front of the teeth, the display 12 will switch to “01b” which represents back of tooth number 1. If an error is made while entering the data into the probe 10, the wheel 13 must be pressed for 5 seconds to invoke correction mode. In correction mode, rotating the wheel 13 causes the flashing cursor to change between digits. Once a particular digit is reached, pressing on the wheel 13 freezes the cursor and unit awaits for new entry via the wheel 13. FIG. 2C shows the probe 10 with display 12 indicating back measurements for tooth number 16. If the battery's voltage is dropped below a threshold value, the unit 10 will display “LOb” while displaying the tooth number and pocket measurements. FIG. 2D depicts the probe 10 with display 12 indicating Low Battery condition. In another embodiment, the display is a 6-character LCD display to provide a better visual interface.

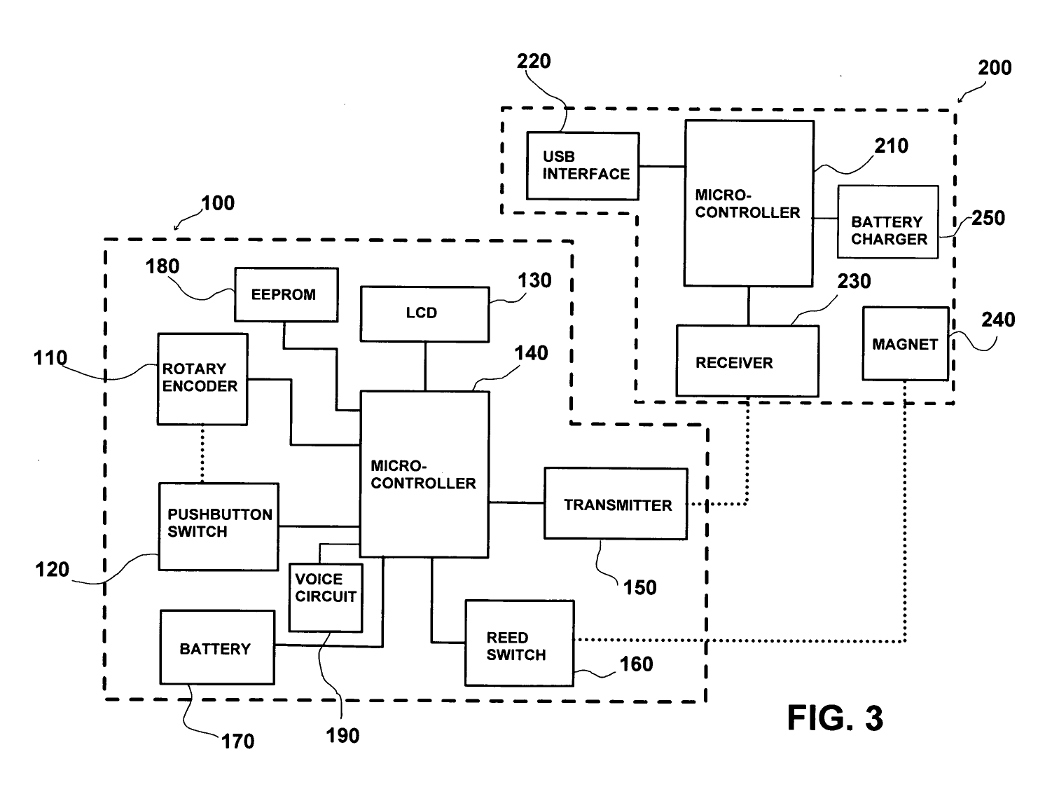

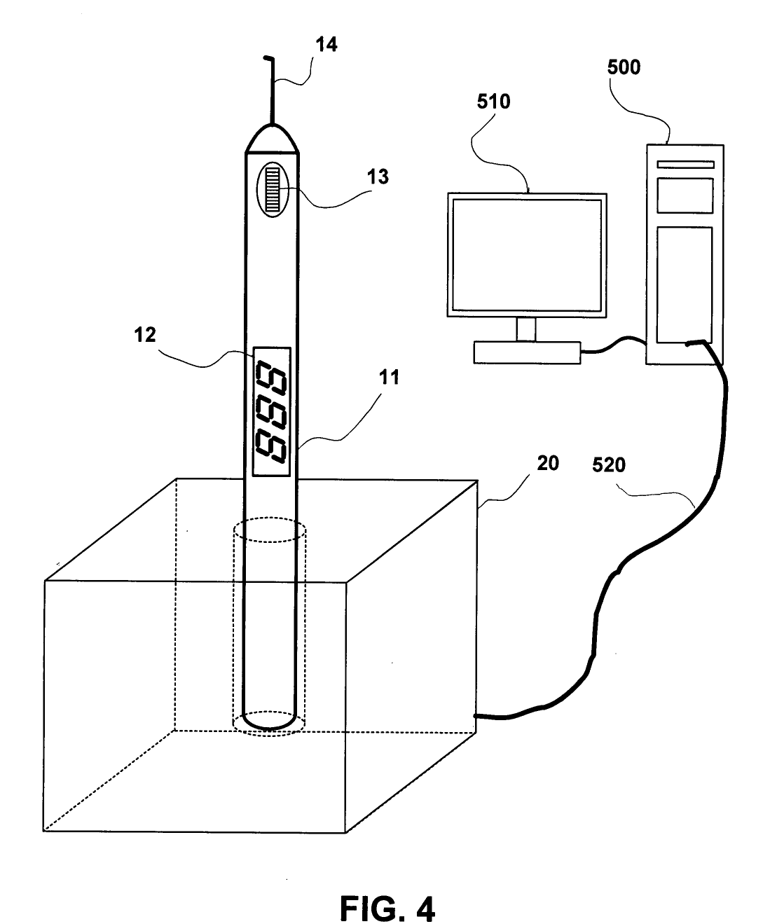

FIG. 3 shows the block diagram of the preferred embodiment. Sub-block 100 is the block diagram for the probe and sub-block 200 is the block diagram for the base unit. The block 100 includes a microcontroller 140 which reads all inputs from the rotary encoder 110 and pushbutton switch 120. The pushbutton switch is activated by pressing on the rotary wheel 13. The microcontroller 140 also reads the signal from reed switch 160. The function of the reed switch will be explained later. The microcontroller 140 also controls the LCD block 130, the EEProm memory block 180, and the radio transmitter 150. The memory 180 may be embedded within the microcontroller 140. The probe includes voice synthesis circuit 190 for audio feedback. The block 200 depicts the base unit. The base unit has a microcontroller 210, radio receiver 230, Universal Serial Bus (USB) interface block 220, magnet 240, and battery charger 250. Once all data has been collected and saved in the probe, the data must then be transferred to a Personal Computer. To transfer the data, the probe must be brought to close proximity of the base unit so that the reed switch 160 is close to the magnet in the base unit 200. When the microcontroller 140 in the probe, detects the presence of the magnet 240, the microcontroller 140 transmits all the data representing the pocket depth via the radio transmitter 150 to the base unit. The base unit receives the data via its radio receiver 230 and microcontroller 210. The microcontroller then transmits the data to the PC via USB interface 220. FIG. 4 shows the probe 10 inserted into the base unit 20 and the base connected to a Personal Computer 500. In another embodiment, the radio transmission between the probe and the base unit may be replaced with an optical transmitter and receiver. In yet another embodiment, the probe may be connected to the base directly without the radio interface using optical fibers. In yet another embodiment, the probe may be connected to the PC directly via a USB interface within the probe.

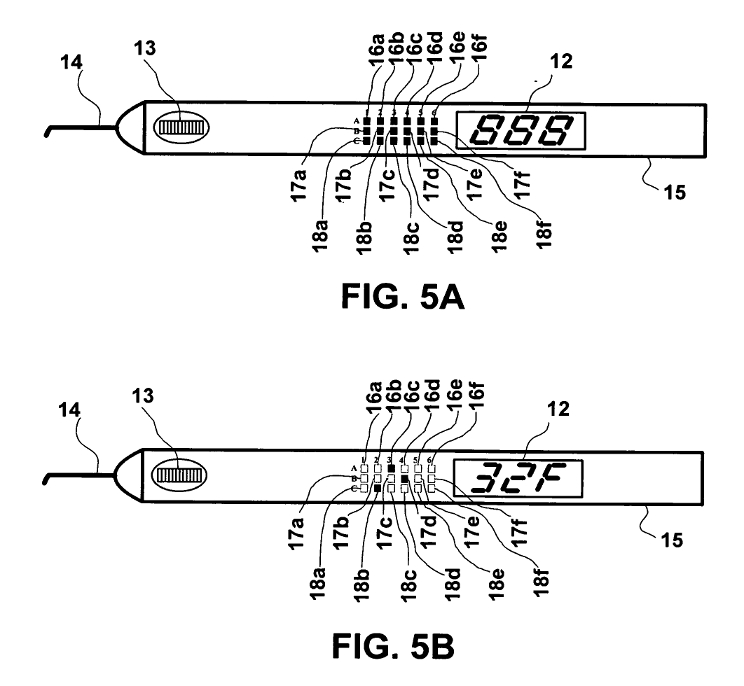

FIG. 5A shows another embodiment of the probe with the added individual LEDs to indicate pocket depth sizes. Three rows of 6 LEDs each are used to show three pocket measurements between 1 and 6. FIG. 5B shows the probe with LEDs 16c, 17d, and 18b turned on. This configuration corresponds to pocket sizes 3 mm, 4 mm, and 2 mm, respectively.

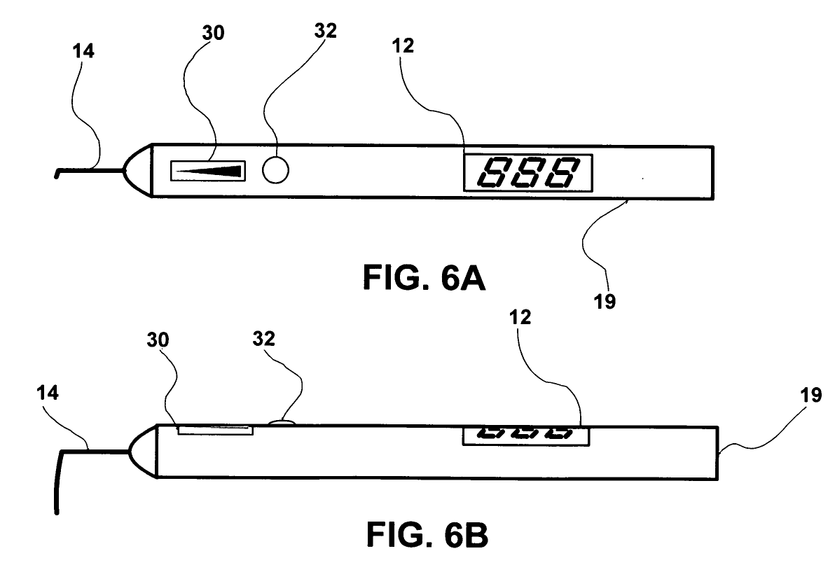

FIG. 6A and FIG. 6B show another embodiment of the probe. In this embodiment, the rotary wheel is replaced with a touch switch 30. The touch switch 30 gives values between 1 and 6 depending on the position of the touch. The touch switch 30 is non-conductive and works through latex or vinyl gloves. Switch 32 is used to record the pocket size once the pocket size value is selected via the touch switch 30. Alternatively, the switch may be omitted and tapping of the touch switch may be used to record the data. However, this method is prone to errors caused by unintentional tapping of the touch switch 30.

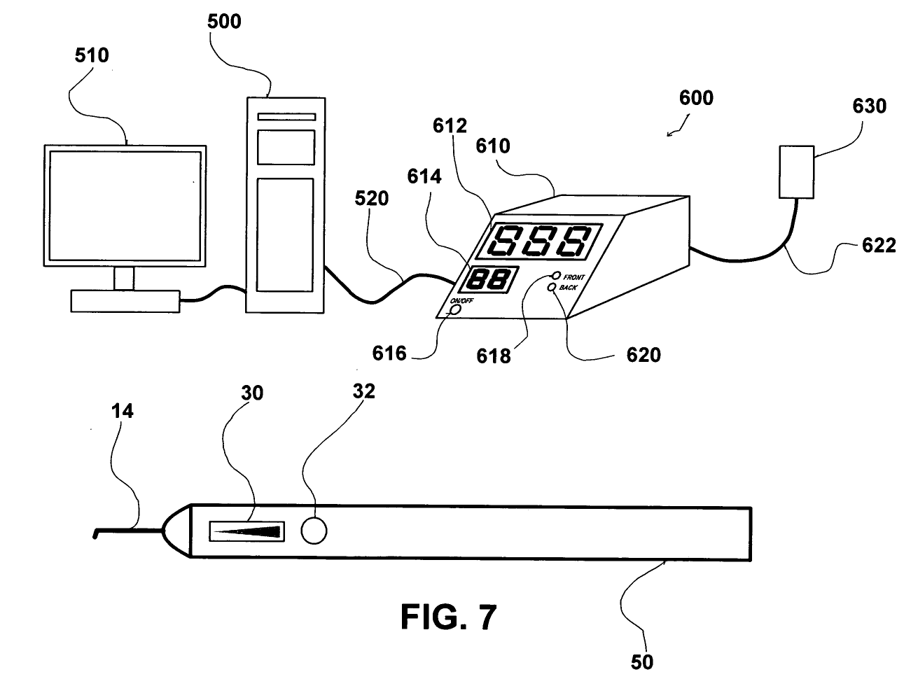

FIG. 7 shows yet another embodiment of the invention. In this embodiment, the display is removed from the probe and included in the base unit. The probe does not record the data and transmits the data to the base during and after each entry. The base unit includes internal memory and a radio receiver. The radio link must be short range so that data from other units in adjacent examination rooms, do not interfere with the unit. The base unit 600, includes 3-digit LCD or LED 612 to show three pocket size values. The base unit also includes a 2-digit LCD or LED 614 to show tooth number and it uses two individual LEDs 618 and 620 to indicate front measurements or back measurements. The base unit also includes voice synthesis to generate audio feedback while data is entered into the probe. The base unit saves the pocket depth data and transmits to the PC 500 via a serial link such as USB. The radio range must be very short, for example 5 feet or less to avoid radio interference from adjacent units. In another embodiment, the radio link between the probe and base unit, is replaced with a optical fiber line.

1. A periodontal pocket depth recorder probe comprising a rotary encoder wheel to select various periodontal pocket depths.

2. The periodontal probe as defined in claim 1, and comprising a digital potentiometer which is attached to the said rotary encoder wheel.

3. The periodontal probe as defined in claim 1, and comprising an analog potentiometer which is attached to the said rotary encoder wheel.

4. The periodontal probe as defined in claim 1, and comprising an optical encoder integrated into the said rotary encoder wheel.

5. The periodontal probe as defined in claim 1, and further including an integral pushbutton switch to record the selected pocket depth values.

6. The periodontal probe as defined in claim 1, and further including a display to show pocket measurements, tooth number, and side of the tooth.

7. The periodontal probe as defined in claim 1, and further including voice synthesis providing audio feedback and commands to guide operator through periodontal pocket measurements.

8. The periodontal probe as defined in claim 1, and further including a permanent memory to save the pocket depth data.

9. The periodontal probe as defined in claim 1, and further including a microcontroller to receive data, display data, and transmit data.

10. The periodontal probe as defined in claim 1, and further including a radio transmitter to send data to a receiving unit.

11. The periodontal probe as defined in claim 1, and further including an optical transmitter to send data via the optical link to a receiving unit utilizing an optical receiver.

12. The periodontal probe as defined in claim 1, and further including a reed switch to detect proximity of a magnet embedded within the receiving unit in order to start data transmission to the receiving unit.

13. The periodontal probe as defined in claim 1, and further including a PC serial interface.

14. A base unit to interface to the probe defined in claim 1, comprising a serial interface to a Personal Computer, and a battery charging circuit.

15. The base unit as defined in claim 14, and further including a microcontroller to receive data.

16. The base unit as defined in claim 14, and further including a magnet to trigger data transfer when the probe is brought in close proximity of the base unit.

17. The base unit as defined in claim 14, and further including a radio receiver to receive data from the transmitting probe.

18. The base unit as defined in claim 14, and further including an optical receiver to receive data from a probe via an optical link.

19. The base unit as defined in claim 14, and further including LCD or LED displays to show pocket depth sizes, tooth number and side of tooth.

20. The base unit as defined in claim 14, and further including an internal permanent memory.

21. A periodontal pocket depth recorder probe comprising a capacitive touch switch to select various pocket depth values.
